(19) United States
(12) Patent Application Publication
(10) Pub. No.: US 2024/0158261 A1
(43) Pub. Date: May 16, 2024

(54) CHARGEABLE WATER PURIFIER

(71) Applicant: Yong JIANG, Guangzhou (CN)

(72) Inventor: Yong JIANG, Guangzhou (CN)

(21) Appl. No.: 17/988,175

(22) Filed: Nov. 16, 2022

(51) Int. Cl. C02F 1/00; C02F 1/44

(52) U.S. Cl. CPC C02F 1/001; C02F 1/441; C02F 1/444; C02F 2209/40; C02F 2209/445

(57) ABSTRACT

A chargeable water purifier includes an inlet pipe comprising a water inlet; a first outlet pipe having a first water outlet configured to provide direct drinking water; a front filter core connected with the inlet pipe; a rear filter core connected with the first outlet pipe; a water pump connected between the front filter core and the rear filter core; and a battery module configured to supply the water pump. The battery module includes a battery and a battery management module electrically connected with the battery, and the battery management module is configured to monitor and manage charging or discharging of the battery.

### TECHNICAL FIELD

The present disclosure relates to the field of water purification, in particular to a chargeable water purifier.

### BACKGROUND ART

Water purifier is used for deeply filtering water according to users' requirement. A function of the water purifier is filtering floating material, heavy metal, bacteria, virus, residual chlorine, sand, rust, microorganism and so on in water. It has high precision filtering technology. A first stage of five-stage filter technology of the water purifier is a filter core which is called a PP cotton filter core. A second stage is a particle active carbon filter core. A third stage is a precise compression active carbon filter core. A fourth stage is reverse osmosis membrane or ultrafiltration membrane. A fifth stage is a post active carbon. The water purifier not only is suitable for areas of serious water pollution, but also can filter residual chlorine in conventional tap water, at the same time, it can improve water taste.

A traditional water purifier is a gradually-tightening water purifier, inner pipelines of the filter core is loose and then tight, a PP melt-blown filter core, a granular carbon, a compressed carbon, a RO reverse osmosis membrane or ultra-filtration membrane, a post active carbon are connected end to end. However, retentate is deposited in the interior of the filter element; it is necessary to manually detach and wash the filter element periodically so as to ensure normal operation of the water purifier.

The traditional water purifier has the shortcoming of a manual control mode (non-automatic or power automatic control), heavy structure, simple principle and single function, and a water purification quality difference between different water purifiers may be obvious.

### SUMMARY

In order to overcome the shortcomings in the traditional water purifier, the present disclosure provides a chargeable water purifier, realizing outdoor charging at any time, and also can be used during charging.

The present disclosure adopts the following technical solution: A chargeable water purifier including an inlet pipe including a water inlet; a first outlet pipe including a first water outlet configured to provide direct drinking water; a front filter core connected with the inlet pipe; a rear filter core connected with the first outlet pipe a water pump connected between the front filter core and the rear filter core; and a battery module configured to supply the water pump, the battery module including a battery and a battery management module electrically connected with the battery, and the battery management module configured to monitor and manage charging or discharging of the battery.

Further, the chargeable water purifier includes a second outlet pipe, the second outlet pipe is connected with the rear filter core, and the second outlet pipe includes a second water outlet configured to provide waste water.

Further, the chargeable water purifier includes a main control processor module, the main control processor module is electrically connected with the battery module and configured to analysis data and process tasks.

Further, the chargeable water purifier includes a charging management module and a charging port, the charging port is electrically connected with the charging management module, the charging management module is electrically connected with the main control processor module, the charging management module is configured to manage voltage and current of a first power signal from the charging port, when the charging port is input the first power signal, the main control processor module controls the battery management module charge the battery, and the first power, signal is configured to power the water pump.

Further, when the voltage of the first power signal is greater than a first predetermined voltage, the charging management module reduces the voltage of the first power signal and provides a reduction voltage to the main control processor module, when the voltage of the first power signal is less than a second predetermined voltage, the charging management module boosts the voltage of the first power signal and provides a boosting voltage to the main control processor module.

Further, the chargeable water purifier includes a solar power module or a portable power source electrically connected with the charging management module and configured to provide a fourth power signal, the main control processor module is also configured to control the battery management module charge the battery by the fourth power signal.

Further, the chargeable water purifier includes a boost driving module, the boost driving module is electrically connected with the main control processor module, the boost driving module is configured to receive the first power signal or a second power signal from the battery and output a third power signal to the water pump, a voltage of the third power signal is greater than a voltage of the first power signal or a voltage, of a second power signal.

Further, the water pump includes a pump body and a pump motor, the pump motor is electrically connected with the main control processor module to receive the third power signal to dive the pump body.

Further, the chargeable water purifier includes a waterway management module, the waterway management module is electrically connected with the main control processor module, the waterway management module is configured to record a first filter time of the front filter core and a second filter time of the rear filter core, when the first filter time is greater than a first predetermined time, the main control processor module provides a first warn signal, and when the second filter time is greater than a second predetermined time, the main control processor module provides a second warn signal.

Further, the chargeable water purifier includes an electromagnetic valve connected between the second water outlet and the rear filter core, the waterway management module is configured to control the electromagnetic valve switch on or switch off.

Further, the chargeable water purifier includes an LED display and key module, the LED display and key module is electrically connected with the main control processor module and configured to display states of the front filter core and the rear filter core, control the chargeable water purifier reset, switch on the chargeable water purifier or switch off the chargeable water purifier.

Further, the chargeable water purifier includes a flow sensor connected between the first water outlet and the rear filter core and configured to detect a flow rate of the first water outlet, the flow sensor is electrically connected with the main control processor module, when the flow rate of the first water outlet is less than a predetermined rate, the main control processor module provides a third warn signal.

Further, the front filter core is a PP cotton filter core.

Further, wherein the rear filter core is a reverse osmosis membrane or ultrafiltration membrane.

The present disclosure also adopts the following technical solution: a chargeable water purifier including an inlet pipe including a water inlet; a first outlet pipe including a first water outlet configured to provide direct drinking water; a front filter core connected with the inlet pipe; a rear filter core connected with the first outlet pipe water pump connected between the front filter core and the rear filter core: and a battery configured to supply the water pump.

Further, the chargeable water purifier includes a second outlet pipe, the second, outlet pipe is connected with the rear filter core, and the second outlet pipe includes a second water outlet configured to provide waste water.

Further, the chargeable water purifier includes a main control processor module, the main control processor module is electrically connected with the battery via a battery module.

Further, the chargeable water purifier includes a charging management module and a charging port, the charging port is electrically connected with the charging management module, the charging management module is electrically connected with the main control processor module, the charging management module is configured to manage voltage and current of a first power signal from the charging port, when the charging port is input the first power signal, the main control processor module controls the battery management module charge the battery, and the first power signal is configured to power the water pump.

Further, when the voltage of the first power signal is greater than a first-predetermined voltage, the charging management module reduces the voltage of the first power signal and provides a reduction voltage to the main control processor module, when the voltage of the first power signal is less than a second predetermined voltage, the charging management module boosts the voltage of the first power signal and provides a boosting voltage to the main control processor module.

Further, chargeable water purifier includes a solar power module or a portable power source electrically connected with the charging management module and configured to provide a fourth power signal, the main control processor module is also configured to control the battery management module charge the battery by the fourth power signal.

The present disclosure has the beneficial effects: the chargeable water purifier does not need to be installed on a water tap, without tap water pressure, only needs to put the inlet pipe into rainwater of outdoor ditch, river water, river water, lake water, sea water and other natural water; the main control processor module control the water pump so as to control the two filter cores to purify outdoor water into directly drinking water without pollutant and other harmful substances. It, is also army soldiers, outdoor workers, travel, exploration, mountaineering, hiking, camping, fishing, hunting and other outdoor activities lovers to obtain a best safety of drinking water when outdoor activities. It can avoid taking large amount of drinking water; it avoids diarrhea and vomiting caused by drinking cleaning drinking water, fever and other diseases. At the same time, it is the emergency water purifying equipment for ensuring the water-drinking safety when the natural disasters such as earthquake and flood happen.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic diagram of a chargeable water purifier according to an embodiment of the present disclosure.

FIG. 2 is a circuit diagram of the chargeable water purifier of FIG. 1.

FIG. 3 is a circuit diagram of the chargeable water purifier according to another embodiment, of the present disclosure.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set, forth in, order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the application, plurality of means two or more, unless otherwise specifically defined.

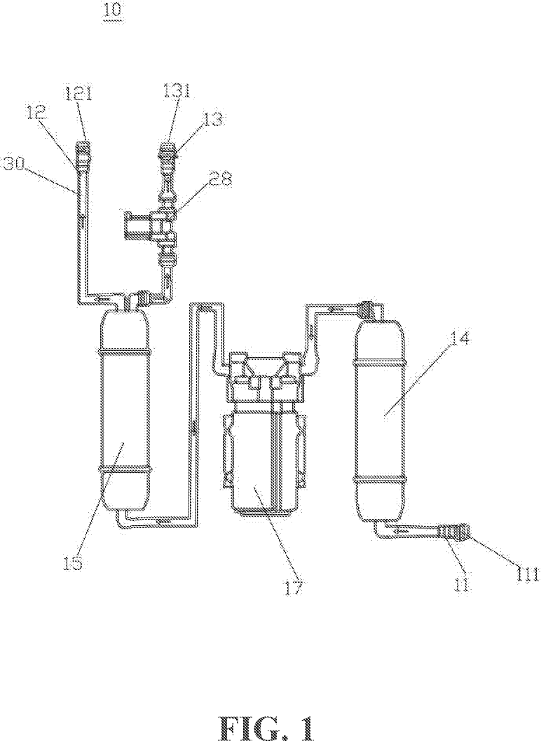

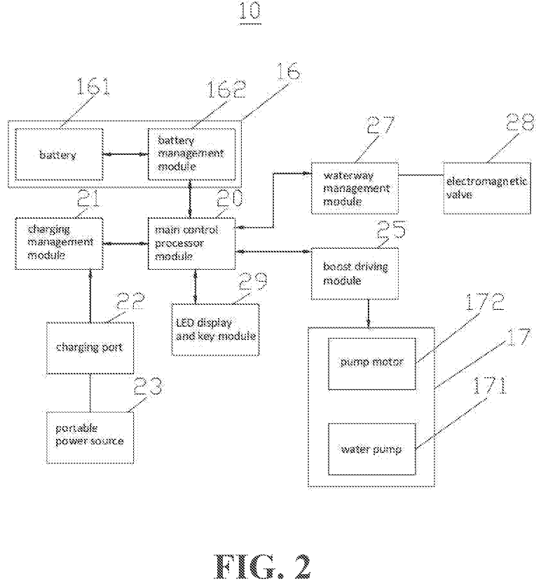

Referring to FIG. 1 and FIG. 2, a chargeable water purifier 10 includes an inlet pipe 11 having a water inlet 111; a first outlet pipe 12 including a first water outlet 121 configured to provide direct drinking water; a second outlet pipe 13; a front filter core connected with the inlet pipe 14; a rear filter core 15 connected with the first outlet pipe 12: a water pump 17 connected between the front filter core 14 and the rear filter core 15; and a battery module 16 configured to supply the water pump 17.

The battery module 16 includes a battery 161 and a battery management module 162 electrically connected with the battery 161, and the battery management module 162 is configured to monitor and manage charging or discharging of the battery 161, such as monitor and manage a charge/discharge temperature of the battery 161, a voltage and a current of the battery;

The second outlet pipe 13 is connected with the rear filter core 15, and the second outlet pipe 13 includes a second water outlet 131 configured to provide waste water. The front filter core 14 is a PP cotton filter core. The rear filter 15 core is a reverse osmosis membrane or ultrafiltration membrane. The battery 161 can be a lithium iron phosphate battery is charged.

The chargeable water purifier 10 includes a main control processor module 20, the main control processor module 20 is electrically connected with the battery module 162 and configured to analysis data and process tasks.

The chargeable water purifier 10 includes a charging management module 21 and a charging port 22, the charging port 22 is electrically connected with the charging management module 21. The charging management module 21 is electrically connected with the main control processor module 20, the charging management module 21 is configured to manage voltage and current of a first power signal from the charging port 22. When the charging port 22 is input the first power signal, the main control processor module 20 controls the battery management module 21 charge the battery 161 until the battery 161 is full, and the first power signal is configured to power the water pump 17.

When the voltage of the first power signal is greater than a first predetermined voltage, the charging management module 21 reduces the voltage of the first power signal and provides a reduction voltage to the main control processor module 20. When the voltage of the first power signal is less than a second predetermined voltage, the charging management module 21 boosts the voltage of the first power signal and provides a boosting voltage to the main control processor module 20.

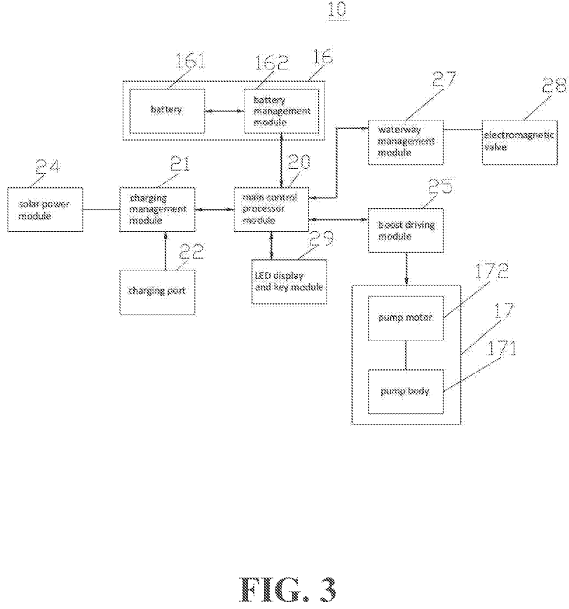

The chargeable water purifier 10 may includes a portable power source 23 electrically connected with the charging management module 21 via the charging port 22 and configured to provide a fourth power signal, the main control processor module 20 is also configured to control the battery management module 162 charge the battery 161 by the fourth power signal until the battery 161 is full. In, other embodiment, referring to FIG. 3, the chargeable water purifier 10 may includes a solar power module 24 electrically connected with the charging management module 21 and configured to provide a fourth power signal, the main control processor module 20 is also configured to control the battery management module 162 charge the battery 161 by the fourth power signal until the battery 161 is full.

The chargeable water purifier 10 includes a boost driving module 25, the boost driving module 25 is electrically connected with the main control processor module 20. The boost driving module 25 is configured to receive the first power signal or a second, power signal from the battery 161 and output a third power signal to the water pump 17. A Voltage of the third power signal is greater than a voltage of the first power signal or a voltage of a second power signal. A voltage of the first power signal may range from 3.3V to 30V, and a current of the first power signal may range from 0.8 A to 3.6 A.

The water pump 17 includes a pump body 171 and a pump motor 172, the pump motor 172 is electrically connected with the main control processor module 20 to receive the third power signal to dive the pump body 171.

The chargeable water purifier 20 includes a waterway management module 26, the waterway management module 16 is electrically connected with the main control processor module 27. The waterway management module 27 is configured to record a first filter time of the front filter core 14 and a second filter time of the rear filter core 15. When the first filter time is greater than a first predetermined time, the main control processor module 20 provides a first warn signal, and when the second filter time is greater than a second predetermined time, the main control processor module 20 provides a second warn signal.

The chargeable water purifier 10 includes an electromagnetic valve 28 connected between the second water outlet 131 and the rear filter core 13, the waterway management module 27 is configured to control the electromagnetic valve 28 switch on or switch off.

The chargeable water purifier includes an LED display and key module 29, the LED display and key module 29 is electrically connected with the main control processor module 20 and configured to display states of the front filter core 12 and the rear filter core 13, control the chargeable water purifier 10 reset, switch on the chargeable water purifier 10 or switch off the chargeable water purifier 10.

The chargeable water purifier 10 includes a flow sensor 30 connected between the first water outlet 121 and the rear filter core 15 and configured to detect a flow rate of the first water outlet 121. The flow sensor is electrically connected with the main control processor module 20, when the flow rate of the first water outlet 121 is less than a predetermined rate, the main control processor module 20 provides a third warn signal.

The chargeable water purifier 10 does not need to be installed on a water tap, without tap water pressure, only needs to put the inlet pipe into rainwater of outdoor ditch, river water, river water, lake water, sea water and other natural water; the main control processor module control the water pump so as to control the two filter cores to purify outdoor water into directly drinking water without pollutant and other harmful substances. It is also army soldiers, outdoor workers, travel, exploration, mountaineering, hiking, camping, fishing, hunting and other outdoor activities lovers to obtain a best safety of drinking water when outdoor activities. It can avoid taking large amount of drinking water; it avoids diarrhea and vomiting caused by drinking cleaning drinking water, fever and other diseases. At the same time, it is the emergency water purifying equipment for ensuring the water-drinking safety when the natural disasters such as earthquake and flood happen.

The chargeable water purifier 10 makes outdoor life of people more beautiful, solves the problem of outdoor domestic water, solving the problem of other outdoor water, purifier, such as small amount of water, non-charging, short working time, using heavy and strene, short service life and so on, the solution overcomes the shortage of the existing technology. The purpose of the present disclosure is to provide a chargeable water purifier, it has fast dismounting, convenient use, saving labour, long pumping time and high water purifying efficiency, and it can be charged at any time and place at any time; it also can be used for charging while using.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed is:

1. A chargeable water purifier, comprising
an inlet pipe comprising a water inlet;
a first outlet pipe comprising a first water outlet configured to provide direct drinking water;
a front filter core connected with the inlet pipe;
a rear filter core connected with the first outlet pipe;
a water pump connected between the front filter core and the rear filter core; and
a battery module configured to supply the water pump, the battery module comprising a battery and a battery management module electrically connected with the battery, and the battery management module configured to monitor and manage charging or discharging of the battery.

2. The chargeable water purifier according to claim 1, wherein the chargeable water purifier comprises a second outlet pipe, the second outlet pipe is connected with the rear filter core, and the second water outlet comprises a second water outlet configured to provide waste water.

3. The chargeable water purifier according to claim 2, wherein the chargeable water purifier comprises a main control processor module, the main control processor module is electrically connected with the battery module and configured to analysis data and process tasks.

4. The chargeable water purifier according to claim 3, wherein the chargeable water purifier comprises a charging management module and a charging port the charging port is electrically connected with the charging management module, the charging management module is electrically connected with the main control processor module, the charging management module is configured to manage voltage and current of a first power signal from the charging port, when the charging port is input the first power signal, the main control processor module controls the battery management module charge the battery, and the first power signal is configured to power the water pump.

5. The chargeable water purifier according to claim 4, wherein when the voltage of the first power signal is greater than a first predetermined voltage, the charging management nodule reduces the voltage of the first power signal and provides a reduction voltage to the main control processor module, when the voltage of the first power signal is less than a second predetermined voltage, the charging management module boosts the voltage of the first power signal and, provides a boosting voltage to the main control processor module.

6. The chargeable water purifier according to claim 4, wherein the chargeable water purifier comprises a solar power module or a portable power source electrically connected with the charging management module and configured to provide a fourth power signal, the main control processor module is also configured to control the battery management module charge the battery by the fourth power signal.

7. The chargeable water purifier according to claim 3, wherein the chargeable water purifier comprises a boost driving module, the boost, driving module is electrically connected with the main control processor module, the boost driving module is configured to receive the first power signal or a second power signal from the battery and output a third power signal to the water pump, a voltage of the third power signal is greater than a voltage of the first power signal or a voltage of a second power signal.

8. The chargeable water purifier according to claim 7, wherein the water pump comprises a pump body and a pump motor, the pump motor is electrically connected with the main control processor module to receive the third power signal to dive the pump body.

9. The chargeable water purifier according to claim 3, wherein the chargeable water purifier comprises a waterway management module, the waterway management module is electrically connected with the main control processor module, the waterway management module is configured to record a first filter tune of the front filter core and a second filter time of the rear filter core, when the first filter time is greater than a first predetermined time, the main control processor module provides a first warn signal, and when the second filter time is greater than a second predetermined time, the main control processor module provides a second warn signal.

10. The chargeable water purifier according to claim 9, wherein the chargeable water purifier comprises an electromagnetic valve connected between the second water outlet and the rear filter core, the waterway management module is configured to control the electromagnetic valve switch on or switch off.

11. The chargeable water purifier according to claim 3, wherein the chargeable water purifier comprises an LED display and key module, the LED display and key module is electrically connected with the main control processor module and configured to display states of the front filter core and the rear filter core, control the chargeable water purifier reset, switch on the chargeable water purifier or switch off the chargeable water purifier.

12. The chargeable water purifier according to claim 3, wherein the chargeable water purifier comprises a flow sensor connected between the first water outlet and the rear filter core and configured to detect a flow rate of the first water outlet, the flow sensor is electrically connected with the main control processor module, when the flow rate of the first water outlet is less than a predetermined rate, the main control processor module provides a third warn signal.

13. The chargeable water purifier according to claim 1, wherein the front filter core is a PP cotton filter core.

14. The chargeable water purifier according to claim 1, wherein the rear filter core is a reverse osmosis membrane or ultrafiltration membrane.

15. A chargeable water purifier, comprising
an inlet pipe comprising a water inlet;
a first outlet pipe comprising a first water outlet configured to provide direct drinking water;
a front filter core connected with the inlet pipe;
a rear filter core connected with the first outlet pipe;
a water pump connected between the front filter core and the rear filter core; and
a battery configured to supply the water pump.

16. The chargeable water purifier according to claim 15, wherein the chargeable water purifier comprises a second outlet pipe, the second outlet pipe is connected with the rear filter core, and the second water outlet comprises a second water outlet configured to provide waste water.

17. The chargeable water purifier according to claim 16, wherein the chargeable water purifier comprises a main control processor module, the main control processor module is electrically connected with the battery via a battery module.

18. The chargeable water purifier according to claim 17, wherein the chargeable water purifier comprises a charging management module and a charging port, the charging port is electrically connected with the charging management module, the charging management module is electrically connected with the main control processor module, the charging management module is configured to manage voltage and current of a first power signal from the charging port, when the charging port is input the first power signal, the main control processor module controls the battery management module charge the battery, and the first power signal is configured to power the water pump.

19. The chargeable water purifier according to claim 18, wherein when the voltage of the first power signal is greater than a first predetermined voltage, the charging management module reduces the voltage of the first power signal and provides a reduction voltage to the main control processor module, when the voltage of the first power signal is less than a second predetermined voltage, the charging management module boosts the voltage of the first power signal and provides a boosting voltage to the main control processor, module.

20. The chargeable water purifier according to claim 18, wherein chargeable water purifier comprises a solar power module or a portable power source electrically connected with the charging management module and configured to provide a fourth power signal, the main control processor module is also configured to control the battery management module charge the battery by the fourth power signal.
